(19) United States
(12) Patent Application Publication
(10) Pub. No.: US 2008/0122386 A1
(43) Pub. Date: May 29, 2008

(54) Control Unit for a Lamp Driver Providing Smooth Transition Between Operation Modes

(75) Inventors: Lambertus Henricus Cornelis De Brouwer, Eindhoven (NL); Patrick John Zijlstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,226

(22) PCT Filed: Jul. 18, 2005
(86) PCT No.: PCT/IB05/52391

§ 371 Date: Jan. 17, 2007

(30) Foreign Application Priority Data
Jul. 21, 2004 (EP) 04103491.9

(51) Int. Cl. H05B 41/288

(52) U.S. Cl. 315/307

(57) ABSTRACT

A control unit for a lamp driver for controlling a lamp during various operation modes. Current through the lamp is increased, preferably linearly, during ignition mode from a first start value to a maximum value. The lamp starts up smoothly and warms up already in ignition mode. Leads to higher lamp voltage and improved switching behavior. May be further improved by changing the duty cycle of a down-converter in order to obtain commutation. May be even further improved by maintaining an alternator running at high frequency (>I 00 kHz) during run-up mode.

### FIELD OF THE INVENTION

The present invention relates to a control unit for a lamp driver, in particular a lamp driver for an ultra-high performance (UHP) light source, e.g. comprised in a projection system. The control unit of the present invention is particularly useful in high pressure mercury (HPM) or high-intensity discharge (HID) lamps.

### BACKGROUND OF THE INVENTION

In prior art designs, the function is to ignite a high pressure mercury (HPM) lamp generating a high voltage. After the lamp is ignited, it is slowly warmed up by a limited current. When the lamp has reached its full power, it goes over to power control keeping the lamp power constant. To realize this a number of modes are defined within the design. These modes are:
1. Idle mode (lamp is off).
2. Calibration mode (the static and dynamic zero current level of lamp current sensor circuit is defined).
3. Ignition mode (lamp is ignited generating a voltage of approximately 5 kV, a constant current is flowing through the lamp).
4. Run-up mode (lamp voltage is slowly rising due to a limited current sent through the lamp, the down-converter is switching with a very low duty cycle).
5. Normal operation mode (after the lamp has reached a certain voltage, the power control algorithm is entered).

Idle mode is re-entered if ‘lamp off’ command is issued, if too high lamp voltage is detected, or if too low lamp current is detected.

US patent application No. US 2003/0127993 discloses a high frequency electronic ballast. The high frequency ballast establishes a lamp current for a gas discharge lamp during starting operation of the gas discharge lamp. The voltage level is maintained substantially constant during an electrode heating phase, corresponding to an ignition mode. During an arc tube heating phase, corresponding to a run-up mode, the voltage is increased in order to reach an operating ampere level of the lamp. An operating ampere level of the lamp current which is greater than or equal to a run-up ampere level is established.

A disadvantage of this is that the switching behavior of the down-converter is bad and the lamp does not run-up smoothly. Another disadvantage is that the transition between various operation modes of the lamp driver is not smooth.

### SUMMARY OF THE INVENTION

It is an object of the present invention to provide a control unit for a lamp driver which provides a smooth transition between various operation modes of the lamp driver, in particular between ignition mode and run-up mode.

It is a further object of the present invention to provide a control unit for a lamp driver in which the switching behavior is improved in relation to prior art lamp drivers.

According to a first aspect of the present invention, the above and other objects are fulfilled by providing a control unit for a lamp driver being adapted to control the operation of a lamp during at least an ignition mode, a run-up mode and a normal operation mode, the control unit comprising:
means for providing, initially in an ignition mode, a predetermined start value of current to the lamp,
means for, subsequently in the ignition mode, increasing the provided current to a predetermined maximum value.

According to a second aspect of the present invention, the above and other objects are fulfilled by providing a method for controlling a lamp driver during at least an ignition mode, a run-up mode and a normal operation mode, the method comprising the steps of
providing, initially in an ignition mode, a predetermined start value of current to the lamp,
subsequently in the ignition mode increasing the provided current to a predetermined maximum value.

Due to the fact that the provided current is increased during the ignition mode, the lamp starts up smoothly and even warms up already in ignition mode, leading to higher lamp voltage. Furthermore, the switching behavior of the lamp is improved.

The predetermined start value of the current to the lamp is preferably between 0.1 A and 0.5 A, depending on the lamp specifications.

The predetermined maximum value of the provided current is preferably between 3.5 A and 4.0 A, depending on the lamp specifications. Most preferably, the predetermined maximum value of the provided current is approximately 3.7 A.

The increasing means is preferably adapted to increase the current at least substantially linearly. This is an advantage because electronic devices in general switch more smoothly to the end value. Furthermore, the life time of the lamp may be improved.

The lamp driver may comprise a down-converter and an alternator. In this embodiment, the control unit is further adapted to change the duty cycle of the down-converter in order to obtain commutation of the current. Thereby the lamp current amplitude and direction of current through the lamp are controlled. Thereby, an even better switching behavior of the down-converter is obtained during the run-up phase.

The duty cycle of the down-converter may be changed by changing the output of a digital-to-analog converter (DAC) to change the set level to the right duty cycle.

In the prior art, in the ignition phase the down-converter as well as the alternator are switching. The alternator is switching at a relatively high frequency, which is preferably above 100 kHz, in order to generate an ignition voltage. When the lamp extinguishes, a lamp current will flow, which will be controlled by the down-converter. After the ignition mode, the alternator will normally decrease from the high frequency to a relatively low frequency, which is preferably below 1 kHz, and the lamp driver will enter the run-up mode. Thus, at run-up the lamp voltage is normally low. The down-converter has to realize very low and high duty cycles outside its normal frequency range in order to control the lamp current. By changing the duty cycle of the down-converter in order to obtain commutation of the current, the above-problems are solved. Preferably, the duty cycle is changed in such a way that the output voltage of the down-converter is below or above the average voltage present at the commutation side. The average voltage at the commutation side depends on the duty cycle of the switching cycle, assuming the frequency is sufficiently high.

The control unit may further be adapted to control the alternator to maintain running at high frequency (i.e. preferably above 100 kHz) during run-up mode, and to cause the frequency to decrease when a measured lamp voltage is equal to a predetermined value.

In prior art lamp drivers, the alternator is only running at high frequency for a specific fixed time, i.e. during the ignition mode. According to this embodiment of the present invention, the high frequency is maintained during the run-up mode. Thus, the decreasing of the frequency must be made dependent on the ending of the run-up mode, rather than being dependent on a specific time interval. The end of the run-up mode can be detected by measuring the lamp voltage. When the lamp voltage reaches a predetermined value, the run-up mode is ended and the normal operation mode is entered. The down-converter side needs to be corrected accordingly. This can be achieved by changing the duty cycle to obtain the right lamp current for the new output voltage of the down-converter. This output voltage changes due to the change of voltage at commutation side and the zener property of the lamp when lit.

The control unit may advantageously be implemented in a lamp driver, which may in turn be inserted in a projection system, which also comprises an ultra-high performance (UHP) light source. The UHP light source may, e.g., be a high pressure mercury (HPM) or a high-intensity discharge (HID) lamp. Alternatively, the lamp driver may be implemented in an illumination system, a luminaire or a display system, e.g. a projection display system. A display system comprising a lamp driver as described may also be employed in a direct view LCD system. Alternatively or additionally, the control unit and/or the lamp driver may be used in any other suitable apparatus.

These and other aspects of the invention will be apparent from and elucidated with reference to the embodiments described hereinafter.

### BRIEF DESCRIPTION OF THE DRAWING

FIG. 1 shows a circuit diagram for a lamp driver according to the invention.

### DESCRIPTION OF THE PREFERRED EMBODIMENTS

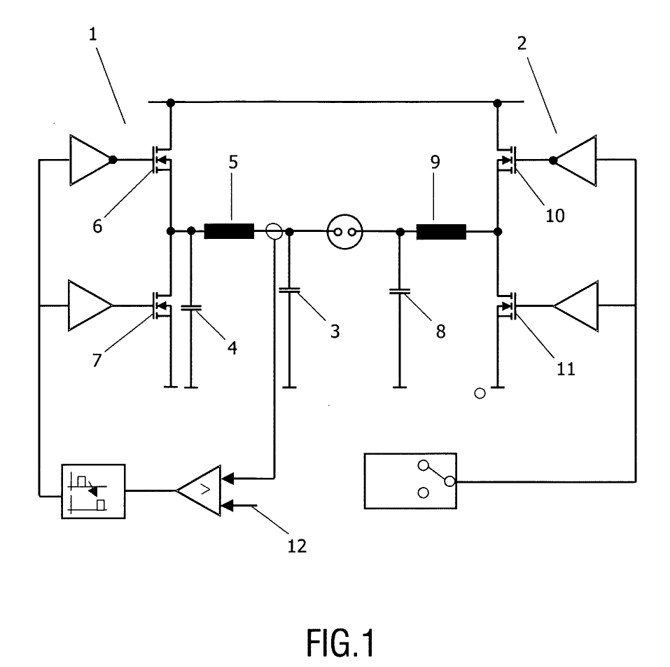

FIG. 1 shows a circuit diagram for a lamp driver according to the invention. The right side of the circuit operates as a down-converter 1 and the left side of the circuit operates as an alternator 2.

The down-converter 1 comprises a first capacitor 3, a second capacitor 4, an inductive coil 5, a first field effect transistor (FET) 6 and a second FET 7. The duty cycle of the down-converter 1 determines the output current, which is the current of induction coil 5.

The alternator 2 comprises a capacitor 8, an inductive coil 9, a first field effect transistor (FET) 10, and a second FET 11. When the second alternator-FET 11 is conducting, the voltage applied to the lamp is the voltage applied to capacitor 3. When, on the other hand, the first alternator-FET 10 is conducting, the lamp current changes direction, and the voltage applied to the lamp is the supply voltage minus the voltage applied to capacitor 3. The right side of the circuit has two functions. It generates the ignition voltage to ignite the lamp, and it functions as an alternator at low frequency after ignition mode has ended. Capacitor 8 and induction coil 9 together form a resonant circuit.

According to the present invention the ignition mode and the run-up mode are separately defined. When going into ignition mode, a start value of the down-converter 1 is chosen, realizing a relatively low current through the lamp when the lamp is ignited. Subsequently, during the ignition mode, the lamp current is increased, preferably linearly, to a maximum value. This ensures that the lamp starts up smoothly and even warms up already in ignition mode. Furthermore, the lamp voltage will be higher due to the warmed up lamp. Due to the higher lamp voltage a higher energy level is present in capacitor 3, preventing the down-converter 1 from not switching and the lamp from extinguishing.

During an ignition phase of the circuit the down-converter 1 as well as the alternator 2 are switching. The alternator 2 is switching in a high frequency mode, preferably with a frequency which is larger than 100 kHz, in order to generate an ignition voltage on capacitor 8. When the lamp extinguishes a lamp current will flow, which will be controlled by the down-converter 1. After the ignition mode the alternator 2 will decrease its switching frequency from the high frequency to a relatively low frequency, preferably below 1 kHz, and the lamp driver will go into a run-up mode.

In one embodiment, however, the alternator 2 is kept switching at a relatively high frequency after the ignition mode. This has the effect that the midpoint at commutation side is approximately half the rail voltage. Commutation of the lamp current can be realized by changing the duty cycle of the down-converter 1 in such a way that the voltage on capacitor 3 is below or above half the rail voltage. Thereby the current is commutating. This has the advantage that the switching behavior of the down-converter during run-up of the lamp is even further improved. Furthermore, the down-converter 1 will always be switching above the oscillation frequency of the alternator resonant circuit 8, 9 in this embodiment. Finally, no low times for switching devices are required in this embodiment.

The high frequency switching of the commutation side must be ended depending on the end of the run-up mode. This instant can be detected by measuring the lamp voltage. When the lamp voltage reaches a specific level the run-up mode has ended and the lamp enters the normal operation mode. The lamp voltage can be easily measured by subtracting half of the rail voltage from the voltage on capacitor 3. Furthermore, the down-converter 1 side needs to be corrected by adjusting a reference current, I_{ref}, which is applied at 12 during the run-up mode. This can be achieved by changing the duty cycle of the down-converter 1 to get the right lamp current for the new output voltage. The duty cycle may be changed by changing the output of a digital-to-analog converter (DAC).

In the original situation it applies that:

$$δ = \frac{{U}_{la}}{{U}_{i}} .$$

In the new situation it applies that:

$$δ = 1 / 2 + \frac{{U}_{la}}{{U}_{i}} .$$

Although the present invention has been described in connection with the preferred embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A control unit for a lamp driver being adapted to control the operation of a lamp during at least an ignition mode, a run-up mode and a normal operation mode, the control unit comprising:
means for providing, initially in an ignition mode, a predetermined start value of current to the lamp,
means for, subsequently in the ignition mode, increasing the provided current to a predetermined maximum value.

2. A control unit according to claim 1, wherein the increasing means is adapted to increase the current at least substantially linearly.

3. A control unit according to claim 1, wherein the lamp driver comprises a down-converter and an alternator, the control unit further being adapted to change the duty cycle of the down-converter in order to obtain commutation of the current.

4. A control unit according to claim 3, further being adapted to control the alternator to maintain running at high frequency during run-up mode, and to cause the frequency to decrease when a measured lamp voltage is equal to a predetermined value.

5. A lamp driver comprising a control unit according to claim 1.

6. A projection system comprising an ultra-high performance (UHP) light source and a lamp driver according to claim 5.

7. An illumination system comprising a lamp driver according to claim 5.

8. A display system comprising a lamp driver according to claim 5.

9. A display system according to claim 8, said display system being a projection display system.

10. A direct view LCD system comprising a display system according to claim 8.

11. A luminaire comprising a lamp driver according to claim 5.

12. A method for controlling a lamp driver during at least an ignition mode, a run-up mode and a normal operation mode, the method comprising the steps of:
providing, initially in an ignition mode, a predetermined start value of current to the lamp,
subsequently in the ignition mode increasing the provided current to a predetermined maximum value.
